(19) United States
(12) Patent Application Publication
(10) Pub. No.: US 2003/0003196 A1
(43) Pub. Date: Jan. 2, 2003

(54) Device and method for confectionary display

(76) Inventor: Melissa Rockenbach, Richardson, TX (US)

Correspondence Address: MILORD & ASSOCIATES, 2029 CENTURY PARK EAST, SUITE 1700, LOS ANGELES, CA, 90067

(21) Appl. No.: 09/897,008

(22) Filed: Jul. 2, 2001

(51) Int. Cl. A23G 1/00

(52) U.S. Cl. 426/104

(57) ABSTRACT

A confectionary device for relaying dynamic messages, the device having a first edible member having a substantially rigid nature, and the first member being in the form of a tablet. A plurality of edible indicia being received on the first member and retained thereon in a secure manner such that the indicia is viewable by an intended recipient and consumable thereby. An attaching means for attaching the indicia to the first member, whereby a desired arrangement of indicia are easily applicable onto the first member to relay a desired message to an intended recipient.

### FIELD OF THE INVENTION

This invention relates to the field of confectionary messages, and particularly to a device for affixing confectionary messages onto an edible platform such that a message can be relayed to an individual that may also consume the message and the edible platform on which the message is affixed.

### BACKGROUND OF THE INVENTION

Means to transmit messages to other individuals have been known in the art. In addition, confectionary and edible items that have preprinted messages thereon have also been known in the art. The following patents disclose such prior art devices.

For example, U.S. Pat. No. 4,988,110 to Zuckerman et al. discloses a combination candy wrapper and board game with the board game and instructions printed on the wrapper. Edible player pieces are contained within the wrapper when it is closed. The wrapper is opened and deployed as a flat member and the edible pieces are moved thereon according to the instructions contained on the wrapper.

U.S. Pat. No. 4,696,473 to Wyzykowski discloses a package for confections containing a game using the confections as playing pieces, wherein the playing piece confections are capable of being consume by the player. The playing piece confections are made in the shape of the letters of the alphabet and may be used to complete phrases, which are originally unknown, on a cardboard game board having crossing lines that define a grid to accommodate the confectionary game pieces.

U.S. Pat. No. 4,979,720 to Robinson discloses a complex machinery mold for forming a synthetic resin tray to be used for imprinting moldable foodstuffs. After the mold is produced with a predetermine inscription thereon, the tray is then filled with a moldable foodstuff such that the message is imprinted thereon.

U.S. Pat. No. 5,096,058 to Juravin et al. discloses a combination greeting card and candy holder made of one-piece construction formed and folded from a single member of material to provide a candy compartment, as well as message display panels. The invention is accomplished by scoring a non-edible material, such as cardboard or plastic, in a predetermined manner to allow folding thereof to accommodate both the candy and the intended message.

U.S. Pat. No. 5,834,047 to Ahn discloses a method and apparatus for imprinting confectionary products with edible ink through the use of molds and vacuums in general and, in particular, Ahn teaches providing molds for imprinting confectionary products with various shapes with edible ink so that the imprinted shape clearly remains until each confectionary product is completely consumed.

U.S. Pat. No. 6,077,144 to Fishman discloses a candy holding device for holding a piece of candy and displaying a random message in response to a movement of the candy. The candy, preferably a lollipop, is inserted to a housing having a message display portion with prewritten messages contained therein, a battery source to allow movement of the messages into the display portion. In addition, Fishman may further include a speaker for producing audible messages.

The prior art does not address the need for a confectionary message that may be written by a user on an edible message board. Therefore, there remains a long standing and continuing need for an advance in the art of confectionary messages and games that is simpler in both design and use, is more economical, efficient in its construction and use, and eliminates the need for complex and expensive methods and devices for imprinting messages on confectionary.

### SUMMARY OF THE INVENTION

Accordingly, it is a general object of the present invention to overcome the disadvantages of the prior art.

In particular, it is an object of the present invention to provide a confectionary device for relaying messages to an intended recipient.

It is another object of the present invention to provide a confectionary device that is enjoyable to use.

It is another object of the present invention to provide a confectionary device that may be easily replenished.

It is another object of the present invention to provide a confectionary device that is economical in cost to manufacture and use.

It is another object of the present invention to provide a confectionary device that is easy to manufacture and use.

It is another object of the present invention to provide a confectionary device that allows consumption of the device after the message is received.

It is yet another object of the present invention to provide a confectionary device that is economical to store and use.

In keeping with the principles of the present invention, a unique confectionary device is herein disclosed. The confectionary device has a first member that is edible and is substantially rigid in nature. The first member may be of any polygonal shape and be substantially tablet shaped. The first member may be of one solid material or may have an outer shell with a confectionary filling enclosed thereby.

A plurality of indicia is adapted to be affixed to the first member in a substantially secure manner. The indicia may be of any suitable form for purposes of illustration, but not limitation, may be letters of an alphabet, numerals, characters, caricatures, symbols, signs, and emblems. The indicia may be made of hard candies which become tacky upon application of water thereto. In addition, the indicia may be made of candies having hard outer shells that require the use of an adhesive means for attachment thereof to the first member. A preferable adhesive means for purposes of illustration, but not limitation, may be a mixture of sugar, syrup, and baking powder.

Such stated objects and advantages of the invention are only examples and should not be construed as limiting the present invention. These and other objects, features, aspects, and advantages of the invention herein will become more apparent from the following detailed description of the embodiments of the invention when taken in conjunction with the accompanying drawings and the claims that follow.

### BRIEF DESCRIPTION OF THE DRAWINGS

It is to be understood that the drawings are to be used for the purposes of illustration only and not as a definition of the limits of the invention.

In the drawings, wherein similar reference characters denote similar elements throughout the several views:

FIG. 1 is a perspective view of the confectionary device illustrating the first member with a plurality of indicia attached thereto.

FIG. 2 is a top plan view of a plurality of varying indicia.

FIG. 3 is a cross-sectional view of the first member with an indicia attached thereto taken along the line 3-3 of FIG. 1.

FIG. 4 is a cross-sectional view of an indicia with an adhesive means applied thereto taken along the line 4-4 of FIG. 2.

FIG. 5 is a perspective view of a plurality of indicia upon a supporting means.

FIG. 6 is a perspective view of a storing means illustrating plurality of indicia and first members contained therein.

### DETAILED DESCRIPTION OF THE INVENTION

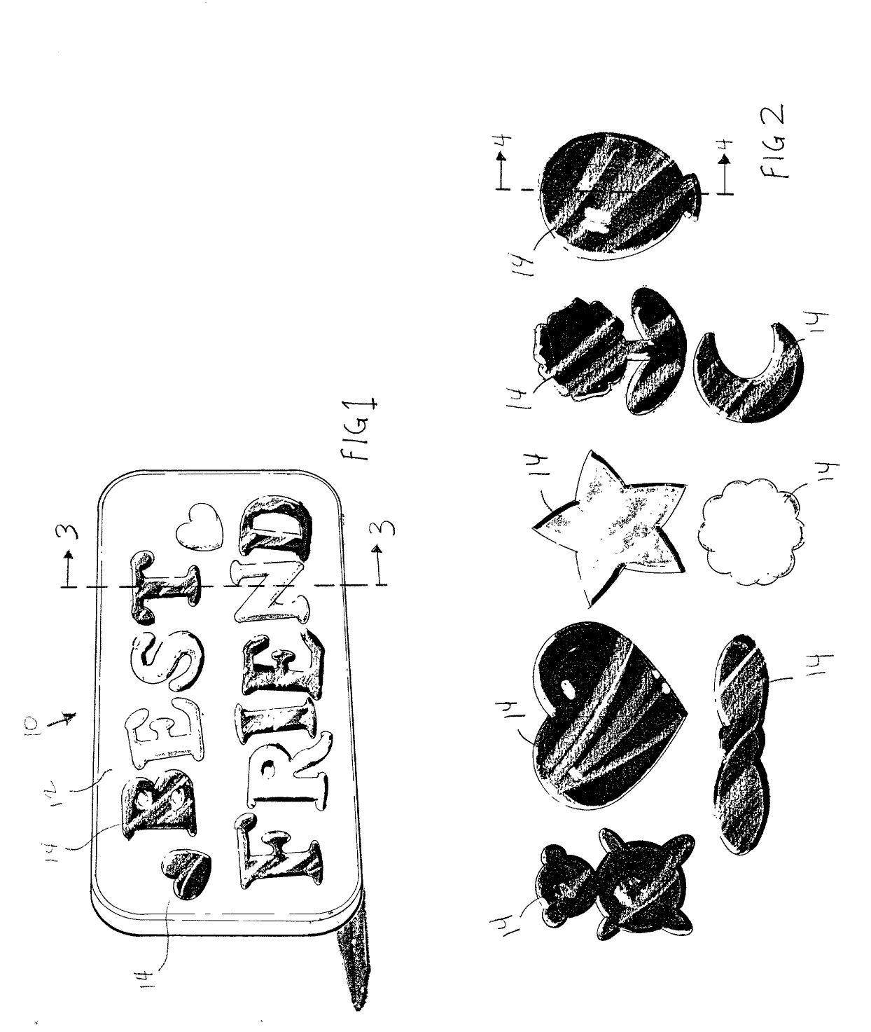

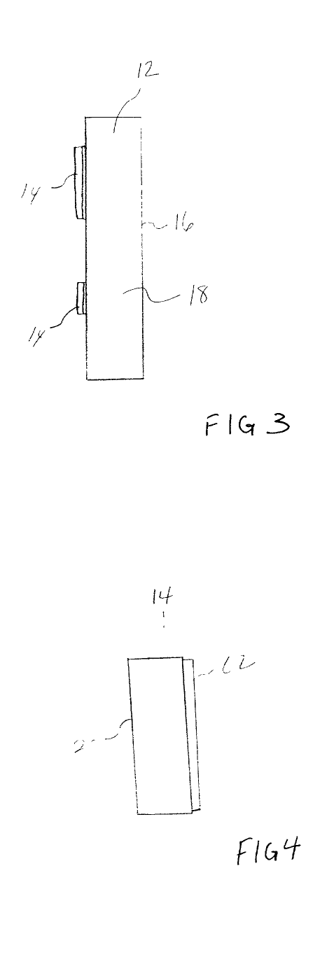

Referring to FIG. 1, therein is illustrated a confectionary display device 10 that is adapted to relay edible messages to the intended recipient. Device 10 has a member 12 which is generally polygonal in shape and is relatively planar in nature in one preferred embodiment, however it is to be understood that member 12 may be circular or any other desired shape. Member 12 is adapted to receive at least an indicia 14 thereon, but preferably receives a plurality of indicia 14, to communicate a message or display an arrangement to the intended recipient. Now also referring FIG. 2, indicia 14 may be, by way of illustration but not limitation, letters of an alphabet, numerals, characters, caricatures, symbols, signs, and emblems.

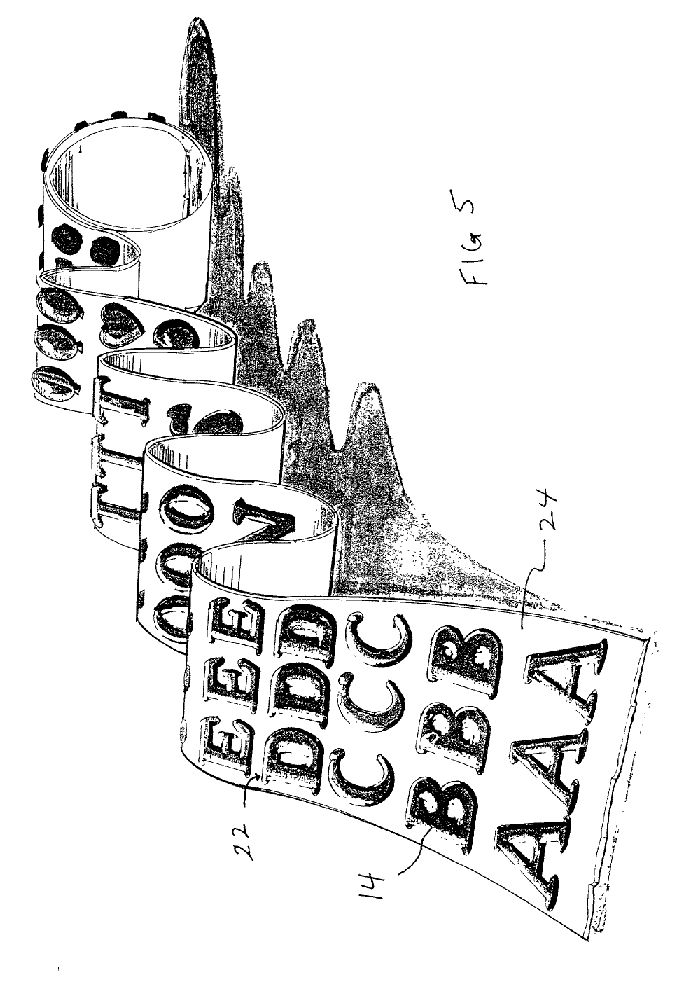

Now also referring to FIGS. 3 and 4, a cross-sectional view of the member 12 and the indicia 14, both affixed thereto and independent thereof, is presented. Member 12 is preferably made of a hard candy substance having an outer shell 16 that is hard in nature. However, member 12 may have an inner substance 18 which may either be soft or hard confectionary that is enclosed within the hard outer shell 16. In one preferred embodiment, member 12 may be a white candy stick that is similar to the LIK-UM-AID® or WONKA® products that are sold under the “FUN DIP” brand, wherein the white candy stick is dipped into a powder based confectionary which adheres thereto and is consumed. The white candy stick thereof may be adapted into a tablet form such as member 12 to allow the adherence of indicia 14 thereto in a substantially secure, yet possibly removable, manner. In an alternate preferred embodiment, the member 12 may be similar to M&M's® candies, which are available through Mars, Inc., with a chocolate filling and a hard outer shell adapted to be of sufficient size to accommodate the adherence of indicia 14 thereto.

Indicia 14 may be selected from a variety of confectionary products that are presently known in the art. For purposes of illustration, but not limitation, indicia 14 may be hard candies such as the JOLLY RANCHERS® candies which are available from Hershey Foods, Inc. The hard candies may be moistened with water which makes the hard candies sticky, thereby allowing adherence thereof directly to member 12. Another confectionary which may also be moistened for adherence to member 12 are jelly gum confectionary, such as the classic gum drop, or GUMMI BEARS available from Harmony Snacks, Inc. or any taffy style confectionary. The gels in these confections are firm and have ample resiliency for shape retention when marketed in stacked bags or in bulk. However, the eating qualities of the gel are desirably a soft tender bite and moderately quick dissolving when chewed. A second type of gel confection is jubes or hard gums produced from the same primary gel ingredients as sugared jellies, but lower in moisture content and generally containing additional starch. All of these confections have in common, firm, resilient gel structure which become tacky when moistened with water and securely adhere to member 12.

Indicia 14 may also be made of candies having a hard outer covering 20 or a shell as described above, wherein a center filling such as starch jelly centers or chocolate centers are coated with a sugar shell. For indicia 14 that have a hard outer covering 20, an adhesive means 22 is utilized to attach the indicia 14 to member 12. Adhesive means 22 may be selected from any known edible tacky or sticky substance that is known in the art which is used in the food preparation industry. For purposes of illustration, but not limitation, in one preferred embodiment, the adhesive means 22 may be made by combining a quarter of a cup of powdered sugar with two tablespoons of light syrup and a pinch of baking powder. The ingredients are mixed together until a pasty liquid is obtained and can be applied to indicia 14. Over time, the pasty liquid becomes solidified and has bonding capability. Indicia 14 having adhesive means 22 is then attached to member 12 wherein the adhesive means 22 hardens and securely attaches indicia 14 to member 12.

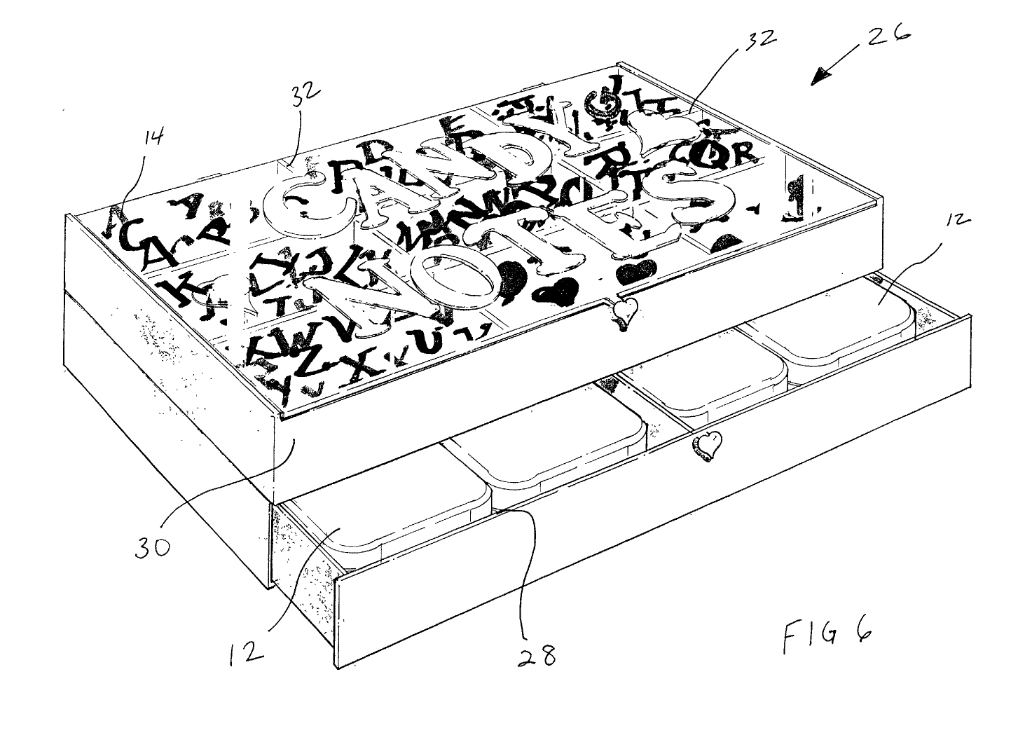

Now referring to FIG. 5, a supporting means 24 is provided for preferably storing indicia 14 that require an adhesive means 22 for attachment to member 12. Supporting means 24, for purposes of illustration, but not limitation, may be an elongated sheet of wax paper such that the adhesive means 22 attaches thereto in a secure yet removable fashion. Furthermore, the wax paper allows the adhesive means 22 to remain tacky thereby facilitating the attachment thereof to member 12.

Now referring to FIG. 6, a storing means 26 is provided for preferably storing indicia 14 that do not have an adhesive means 22 therewith and also for storing a plurality of members 12. Storing means 26 preferably has a first compartment 28 that is adapted to accommodate a plurality of members 12. Storing means 26 also has a second compartment 30 for accommodating a plurality of indicia 14. Second compartment 30 may also be divided into a plurality of sub-compartments by at least a dividing means 32, such that varying indicia 14 may be grouped together in the sub-compartments.

While the above description contains many specificities, these should not be construed as limitations on the scope of the invention, but rather as an exemplification of preferred embodiments thereof. Many other variations are possible without departing from the essential spirit of this invention. Accordingly, the scope of the invention should be determined not by the embodiments illustrated, but by the appended claims and their legal equivalents.

What is claimed is:

1. A confectionary display device, comprising
an edible first member;
at least an edible indicia that is received by said first member and maintained thereon in a secure manner such that said indicia is viewable by an intended recipient.

2. The device of claim 1, wherein said first member is substantially rigid.

3. The device of claim 2, wherein said first member is substantially planar.

4. The device of claim 2, wherein said first member is of a shape selected from a group consisting of square, triangle, circle, rectangle, pentagon, hexagon, and octagon.

5. The device of claim 2, wherein said first member is comprised of an outer shell that encloses an inner substance therein.

6. The device of claim 5, wherein said outer shell is a hard candy material.

7. The device of claim 5, wherein said inner substance is made of a substance selected from chocolate and jelly gum confectionary.

8. The device of claim 1, wherein said member is in the shape of a tablet.

9. The device of claim 8, wherein said indicia is selected from a group consisting of a hard candy, jelly gum confectionary, hard gum confectionary.

10. The device of claim 9, wherein said indicia becomes sticky upon application of water to said indicia.

11. The device of claim 8, wherein an adhesive means is used to attach said indicia to said member.

12. The device of claim 11, wherein said adhesive means consists of an edible tacky substance that may be applied to a covering of said indicia.

13. The device of claim 11, wherein said adhesive means consists of a mixture of sugar, syrup, and baking powder.

14. A confectionary device for relaying a message, the device comprising:
a first edible member having a substantially rigid nature;
a plurality of edible indicia being received on said first member and retained thereon in a secure manner such that said indicia is viewable by an intended recipient;
whereby a user may place any desired indicia onto said first member to relay a desired message.

15. The device of claim 14, wherein said first member is in a tablet form of sufficient size to accommodate a plurality of said indicia and is made of a hard candy material.

16. The device of claim 14, wherein said indicia is selected from a group consisting of a hard candy, jelly gum confectionary, and hard gum confectionary.

17. The device of claim 16, wherein said plurality of indicia become sticky upon application of water to said plurality indicia, thereby attaching the plurality of indicia to said first member.

18. The device of claim 15, wherein an adhesive means consisting of a mixture of sugar, syrup, and baking powder is applied to a covering on said indicia and thereby attaches said plurality of indicia to said first member.

19. A confectionary device for relaying dynamic messages, the device comprising:
a first edible member having a substantially rigid nature, and said first member being in the form of a tablet;
a plurality of edible indicia being received on said first member and retained thereon in a secure manner such that said indicia is viewable by an intended recipient and consumable thereby;
an attaching means for attaching said indicia to said first member;
whereby a desired arrangement of indicia are easily applicable onto said first member to relay a desired message to an intended recipient.

20. The device of claim 19, wherein said indicia is selected from a group consisting of a hard candy, jelly gum confectionary, and hard gum confectionary.
